(19) United States
(12) Patent Application Publication
(10) Pub. No.: US 2018/0323615 A1
(43) Pub. Date: Nov. 8, 2018

(54) POWER CONVERSION APPARATUS AND METHOD

(71) Applicant: ELECTRONICS AND TELECOMMUNICATIONS RESEARCH INSTITUTE, Daejeon (KR)

(72) Inventors: Se-Wan HEO, Daejeon (KR); Wan-Ki PARK, Daejeon (KR); Il-Woo LEE, Daejeon (KR)

(21) Appl. No.: 15/685,507

(22) Filed: Aug. 24, 2017

(30) Foreign Application Priority Data
May 2, 2017 (KR) 10-2017-0056557

(51) Int. Cl. H02J 3/38; H02J 7/00; G05B 11/01; H02J 9/06

(52) U.S. Cl. CPC H02J 3/381; H02J 7/0063; H02J 3/385; H02J 9/061; G05B 11/01

(57) ABSTRACT

A power conversion apparatus includes a first power conversion unit for converting power produced by a power generation device while being connected to the power generation device and transmitting converted power to any one of a grid and an energy storage device, a second power conversion unit for converting power discharged from the energy storage device while being connected to the energy storage device and transmitting converted power to the first power conversion unit, and a switch control unit for switching the first power conversion unit to any one of the grid and the energy storage device depending on a state of the grid and then transmitting power of the first power conversion unit.

### CROSS REFERENCE TO RELATED APPLICATION

This application claims the benefit of Korean Patent Application No. 10-2017-0056557, filed May 2, 2017, which is hereby incorporated by reference in its entirety into this application.

### BACKGROUND OF THE INVENTION

### 1. Technical Field

The present invention relates generally to new renewable energy technology and, more particularly, to power conversion technology for a grid-connected new renewable power generation system.

### 2. Description of Related Art

Electricity may be produced by various types of power sources. In the case of thermal power generation, problems such as environmental pollution and the emission of carbon dioxide may be caused. Therefore, recently, the utilization of new renewable energy sources that do not cause environmental pollution problems has increased. Representatively, photovoltaic power generation is used, and new renewable energy from wind power and biomass is also widely used. Especially in Europe, the ratio of the amount of new renewable energy used to the total amount of power generated is relatively high.

In order to use electricity generated from a power generation source, the electricity must be generally converted into a suitable voltage using a power conversion device. The electricity is converted into an Alternating Current (AC) voltage for the purpose of connecting to a grid (system), and is converted into a Direct Current (DC) voltage for the purpose of being directly used or being stored in a battery. In the case of photovoltaic power generation, an algorithm such as Maximum Power Point Tracking (MPPT) is used during the use of the power conversion procedure.

Most photovoltaic power generation uses only power conversion devices, which are installed to be operated in a grid-connected manner. In this case, when a power failure occurs in the grid, the power conversion devices that are operated in a grid-connected manner stop their respective operations to prevent isolated operation. On the other hand, when energy is stored using a large-capacity energy storage device rather than in a form of being directly connected to the grid, the large-capacity energy storage device may continuously produce energy without stopping the operation thereof even if a power failure occurs in the grid. However, since the large-capacity energy storage device is very expensive, great expenses are additionally incurred, and thus it is not economical.

Meanwhile, Korean Patent No. 10-1663445 entitled “Uninterruptible Power Supply System using Energy Storage System and Operating Method of the Uninterruptible Power Supply System” discloses an Uninterruptable Power Supply system (UPS) based on a UES (UPS+ESS) having a form in which an Energy Storage System (ESS) is combined with the UPS.

However, since the technology disclosed in Korean Patent No. 10-1663445 uses a single DC-AC voltage conversion device, it is difficult to efficiently connect a new renewable power generation source to a grid.

### SUMMARY OF THE INVENTION

Accordingly, the present invention has been made keeping in mind the above problems occurring in the prior art, and an object of the present invention is to efficiently use power produced by a power generator even when a grid is in a power failure state.

Another object of the present invention is to contribute to the recovery of the power failure state of a grid.

In accordance with an aspect of the present invention to accomplish the above objects, there is provided a power conversion apparatus, including a first power conversion unit for converting power produced by a power generation device while being connected to the power generation device, and transmitting the converted power to any one of a grid and an energy storage device, a second power conversion unit for converting power discharged from the energy storage device while being connected to the energy storage device, and transmitting converted power to the first power conversion unit, and a switch control unit for switching the first power conversion unit to any one of the grid and the energy storage device depending on a state of the grid, and then transmitting power of the first power conversion unit.

The switch control unit may be configured to, when the grid is in a normal state, perform a normal mode in which the first power conversion unit is connected to the grid.

The switch control unit may be configured to, when the grid is in a power failure state, perform a power failure mode, in which the first power conversion unit is connected to the energy storage device, by switching a connection between the first power conversion unit and the grid.

The switch control unit may be configured to, when the grid is in a power failure recovery state of recovering from a power failure, perform a power failure recovery mode, in which the first power conversion unit is connected to the grid, by switching a connection between the first power conversion unit and the energy storage device.

The first power conversion unit may be configured to, when in the power failure mode, convert a Direct Current (DC) voltage of the power generation device into a DC voltage corresponding to the energy storage device, and then charge the energy storage device with the DC voltage.

The first power conversion unit may be configured to, when in any one of the normal mode and the power failure recovery mode, convert the DC voltage of the power generation device into an Alternating Current (AC) voltage corresponding to the grid, and transmit the AC voltage to the grid.

The second power conversion unit may be configured to, when in the power failure recovery mode, convert a DC voltage discharged from the energy storage device into a DC voltage corresponding to the power generation device and transmit the DC voltage to the first power conversion unit.

The second power conversion unit may be configured to, when in the power failure recovery mode, discharge the energy storage device until a charge voltage of the energy storage device becomes less than or equal to a preset threshold.

The power generation device may be configured to, when in any one of the normal mode and the power failure recovery mode, produce high-voltage power and transmit the high-voltage power to the grid and, when in the power failure mode, produce low-voltage power and charge the energy storage device with the low-voltage power.

The power generation device may include multiple power generation modules and multiple switches, and the power generation device may switch a connection between the multiple power generation modules to any one of a series-connected configuration and a parallel-connected configuration using the multiple switches depending on a state of the grid.

The power generation device may be configured to, when in any one of the normal mode and the power failure recovery mode, produce power by switching the connection between the multiple power generation modules to the series-connected configuration using the multiple switches.

The power generation device may be configured to, when in the power failure mode, produce power by switching the connection between the multiple power generation modules to the parallel-connected configuration using the multiple switches.

In accordance with another aspect of the present invention to accomplish the above objects, there is provided a power conversion method using a power conversion apparatus, including when a grid connected to the power conversion apparatus is in a normal state, converting power produced by a power generation device and transmitting the converted power to the grid, when the grid is in a power failure state, charging the power produced by the power generation device in an energy storage device, and when the grid is in a power failure recovery state of recovering from a power failure, discharging the energy storage device and transmitting power, discharged from the energy storage device, together with the power produced by the power generation device, to the grid.

Converting the power and transmitting the converted power to the grid may be configured to, when the grid is in the normal state, perform a normal mode in which the power generation device is connected to the grid.

Converting the power and transmitting the converted power to the grid may be configured to, when in the normal mode, convert a DC voltage of the power generation device into an AC voltage corresponding to the grid and transmit the AC voltage to the grid.

Charging the power in the energy storage device may be configured to, when the grid is in the power failure state, perform a power failure mode, in which the power generation device is connected to the energy storage device, by switching a connection between the power generation device and the grid.

Charging the power in the energy storage device may be configured to, when in the power failure mode, convert the DC voltage of the power generation device into a DC voltage corresponding to the energy storage device, and then charge the energy storage device with the DC voltage.

Discharging the energy storage device and transmitting the discharged power, together with the power produced by the power generation device, to the grid may be configured to, when the grid is in the power failure recovery state, perform a power failure recovery mode, in which the power generation device is connected to the grid, by switching a connection between the power generation device and the energy storage device.

Discharging the energy storage device and transmitting the discharged power, together with the power produced by the power generation device, to the grid may be configured to, when in the power failure recovery mode, convert a DC voltage discharged from the energy storage device into a DC voltage corresponding to the power generation device, convert the DC voltage, together with the power produced by the power generation device, into an AC voltage corresponding to the grid, and transmit the AC voltage to the grid.

Discharging the energy storage device and transmitting the discharged power, together with the power produced by the power generation device, to the grid may be configured to, when in the power failure recovery mode, discharge the energy storage device until a charge voltage of the energy storage device becomes less than or equal to a preset threshold.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram of a grid-connected power generation system according to an embodiment of the present invention;

FIG. 2 is a block diagram showing in detail an example of the power conversion apparatus illustrated in FIG. 1;

FIG. 3 is a block diagram illustrating the state in which the power conversion apparatus according to an embodiment of the present invention is operating in a normal mode;

FIG. 4 is a block diagram illustrating the state in which the power conversion apparatus according to an embodiment of the present invention is operating in a power failure mode;

FIG. 5 is a block diagram illustrating the state in which the power conversion apparatus according to an embodiment of the present invention is operating in a power failure recovery mode;

FIG. 6 is a block diagram illustrating a power generation device according to an embodiment of the present invention;

FIG. 7 is a block diagram illustrating a series-connected configuration of the power generation device according to an embodiment of the present invention;

FIG. 8 is a block diagram illustrating a parallel-connected configuration of the power generation device according to an embodiment of the present invention; and

FIG. 9 is an operation flowchart illustrating a power conversion method according to an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clearer.

In the present specification, it should be understood that terms such as “include” or “have” are merely intended to indicate that components are present, and are not intended to exclude the possibility that one or more other components thereof will be present or added, unless a description to the contrary is specifically pointed out in context.

Hereinafter, preferred embodiments of the present invention will be described in detail with reference to the attached drawings.

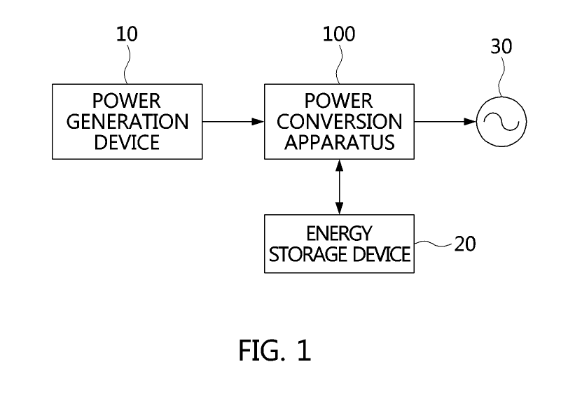

FIG. 1 is a block diagram of a grid-connected power generation system according to an embodiment of the present invention.

Referring to FIG. 1, it can be seen that the grid-connected power generation system includes a power generation device 10, an energy storage device 20, and a power conversion apparatus 100, and that the power conversion apparatus 100 is connected to a grid 30.

The power generation device 10 may transmit power to the grid 30 through the power conversion apparatus 100.

The power generation device 10 may be a power generator that uses various types of new renewable energy.

For example, the power generation device 10 may be a photovoltaic power generator, a wind power generator, a solar power generator, or the like.

The energy storage device 20 may be charged with the power of the power generation device 10 through the power conversion apparatus 100 when the grid 30 is in a power failure state, and may be discharged to transmit the charged power to the grid through the power conversion apparatus 100 when the grid is in the state in which it is recovering from a power failure (power failure recovery state).

Here, the energy storage device 20 may use various storage schemes.

For example, the energy storage device 20 may be a Battery Energy Storage System (BESS), such as one incorporating a type of battery that uses a chemical energy storage scheme.

Here, the energy storage device 20 may correspond to a battery or a super-capacitor, and may perform a charging operation even in the state in which almost no charged energy is present.

The energy storage device 20 may correspond to a lithium-ion battery, a lead storage cell, a sodium sulfur battery, a redox flow battery, or the like.

The power conversion apparatus 100 may convert power of a DC voltage produced by the power generation device 10 into an AC voltage corresponding to the grid 30 and may transmit the AC voltage to the grid 30.

Here, when the grid 30 is in a power failure state, the power conversion apparatus 100 may convert the power produced by the power generation device 10 into a DC voltage corresponding to the energy storage device 20 and may then charge power in the energy storage device 20.

Here, when the grid 30 is in the state in which it is recovering from a power failure (power failure recovery state), the power conversion apparatus 100 may transmit the power produced by the power generation device 10, together with the power discharged from the energy storage device 20, to the grid 30 until the charge voltage of the energy storage device 20 becomes less than or equal to a preset threshold.

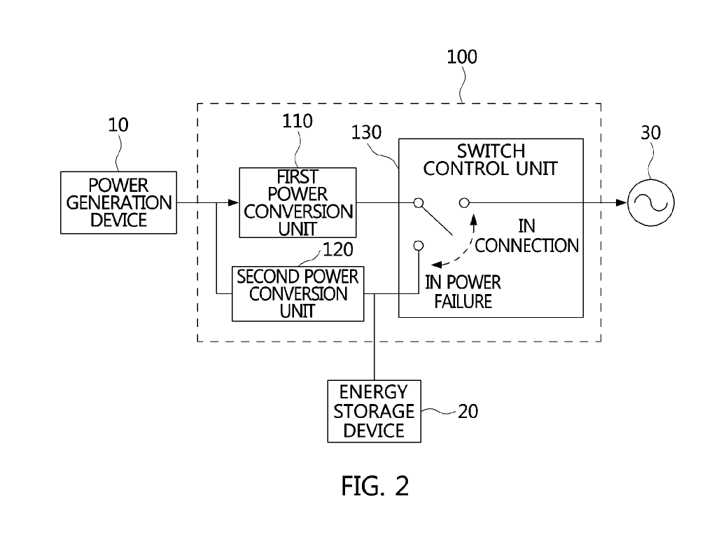

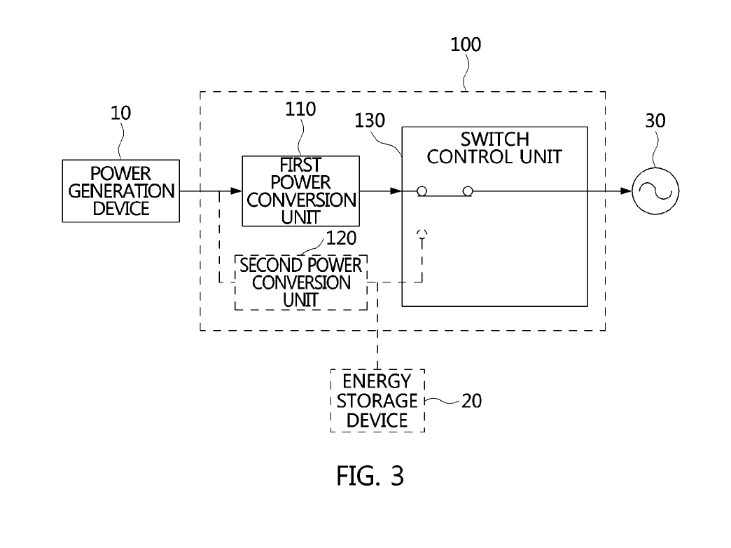

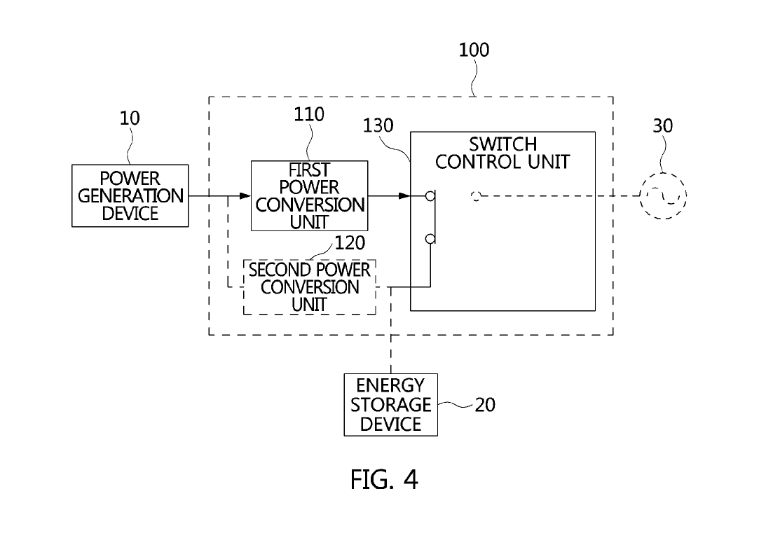

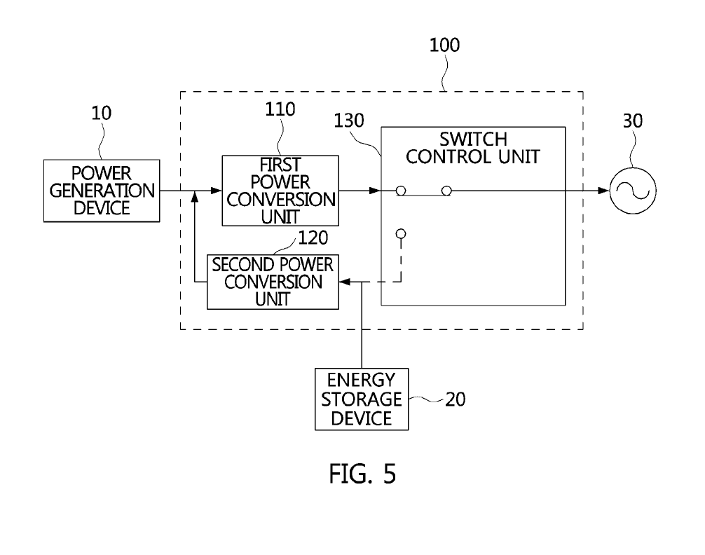

FIG. 2 is a block diagram showing in detail an example of the power conversion apparatus illustrated in FIG. 1. FIG. 3 is a block diagram illustrating the state in which the power conversion apparatus according to an embodiment of the present invention is operating in a normal mode. FIG. 4 is a block diagram illustrating the state in which the power conversion apparatus according to an embodiment of the present invention is operating in a power failure mode. FIG. 5 is a block diagram illustrating the state in which the power conversion apparatus according to an embodiment of the present invention is operating in a power failure recovery mode.

Referring to FIG. 2, the power conversion apparatus 100 according to the embodiment of the present invention includes a first power conversion unit 110, a second power conversion unit 120, and a switch control unit 130.

The first power conversion unit 110 may represent a first power converter which is a machine, a device or a facility to be used for a power conversion.

The second power conversion unit 120 may represent a second power converter which is a machine, a device or a facility to be used for a power conversion.

The switch control unit 130 may represent a switch controller which is a machine, a device, a facility or a computer to be used to control operations of the first power conversion unit 110 and the second power conversion unit 120.

The first power conversion unit 110 may convert the power produced by the power generation device 10 while being connected to the power generation device 10 and may transmit the converted power to any one of the grid 30 and the energy storage device 20.

The second power conversion unit 120 may convert the power discharged from the energy storage device 20 while being connected to the energy storage device 20 and may transmit the converted power to the first power conversion unit 110.

The switch control unit 130 switches the first power conversion unit 110 to any one of the grid 30 and the energy storage device 20 depending on the state of the grid 30, and may then transmit the power of the first power conversion unit 110.

Referring to FIG. 3, the state in which the power conversion apparatus according to an embodiment of the present invention is operating in a normal mode is illustrated.

When the grid 30 is in a normal state, the switch control unit 130 may perform the normal mode in which the first power conversion unit 110 is connected to the grid 30.

Here, when in any one of the normal mode and a power failure recovery mode, the first power conversion unit 110 may convert the DC voltage of the power generation device 10 into an AC voltage corresponding to the grid 30, and may transmit the AC voltage to the grid 30.

Alternatively, the first power conversion unit 110 may perform DC-DC conversion and subsequently perform DC-AC conversion using a dual-conversion form, such as DC-DC-AC conversion.

At this time, since the power generated by the power generation device 10 is transmitted to the grid through the first power conversion unit 110, the second power conversion unit 120 and the energy storage device 20 may not be used.

In this case, the energy storage device 20 and the second power conversion unit 120 enter a low-power-consumption mode, in which little power consumption may be incurred.

Here, when in the normal mode, the power generation device 10 may generate power of a high voltage and may transmit the generated power to the grid 30.

The power generation device 10 may be a power generator that enables both high-voltage operation and low-voltage operation to be performed.

Referring to FIG. 4, the state in which the power conversion apparatus according to an embodiment of the present invention is operating in a power failure mode is illustrated.

When the grid 30 is in a power failure state, the switch control unit 130 may perform the power failure mode, in which the first power conversion unit 110 is connected to the energy storage device 20, by switching the connection between the first power conversion unit 110 and the grid 30.

Here, when in the power failure mode, the first power conversion unit 110 may convert the DC voltage of the power generation device 10 into a DC voltage corresponding to the energy storage device 20, and may then charge the energy storage device 20 with the DC voltage.

When the power generated by the power generation device 10 is charged in the energy storage device 20 through the first power conversion unit 110, the second power conversion unit 120 may not be used.

That is, the first power conversion unit 110 may change the conversion mode to a DC-AC conversion mode or a DC-DC conversion mode. Here, the first power conversion unit 110 may change the conversion mode either in response to an external command attributable to the power failure in the grid 30 or via internal detection thereof. The first power conversion unit 110 may perform the DC-AC conversion mode when the grid 30 is not in a power failure state, and may then perform the DC-DC conversion mode when a power failure occurs in the grid 30.

The first power conversion unit 110 may stop charging when the voltage of the energy storage device 20 reaches a preset threshold or more. Since the voltage of the energy storage device 20 is changed depending on a charged state, the energy storage device 20 stops its operation by itself so that the voltage falls within the range of the operating voltage of the first power conversion unit 110, thus protecting both the first power conversion unit 110 and the energy storage device 20.

Here, when in the power failure mode, the power generation device 10 produces power of a low voltage, thus charging the energy storage device 20 with the low voltage.

Referring to FIG. 5, the state in which the power conversion apparatus according to an embodiment of the present invention is operating in a power failure recovery mode is illustrated.

When the grid 30 is in a power failure recovery state, the switch control unit 130 may perform the power failure recovery mode, in which the first power conversion unit 110 is connected to the grid 30, by switching the connection between the first power conversion unit 110 and the energy storage device 20.

In this case, when in the power failure recovery mode, the first power conversion unit 110 may convert the DC voltage of the power generation device 10 into an AC voltage corresponding to the grid 30, and may then transmit the AC voltage to the grid 30.

When in the power failure recovery mode, the second power conversion unit 120 may convert the DC voltage discharged from the energy storage device 20 into a DC voltage corresponding to the power generation device 10 and may transmit the DC voltage to the first power conversion unit 110.

Here, the first power conversion unit 110 may transmit the power produced by the power generation device 10, together with the power discharged from the energy storage device 20, to the grid 30.

When the second power conversion unit 120 is in the power failure recovery mode, the second power conversion unit 120 and the energy storage device 20 stop their respective operations and may change the operation mode of the power conversion apparatus 100 to the normal mode, as shown in FIG. 3, when the charge voltage of the energy storage device 20 becomes less than or equal to a preset threshold.

Further, the second power conversion unit 120 may have a power conversion capacity less than that of the first power conversion unit 110. Here, the second power conversion unit 120 may transmit the power to the first power conversion unit 110 by discharging the energy storage device 20 for a long period of time with a small conversion capacity after the recovery from the power failure of the grid 30.

In this case, when in the power failure recovery mode, the power generation device 10 may produce high-voltage power and then transmit the high-voltage power to the grid 30.

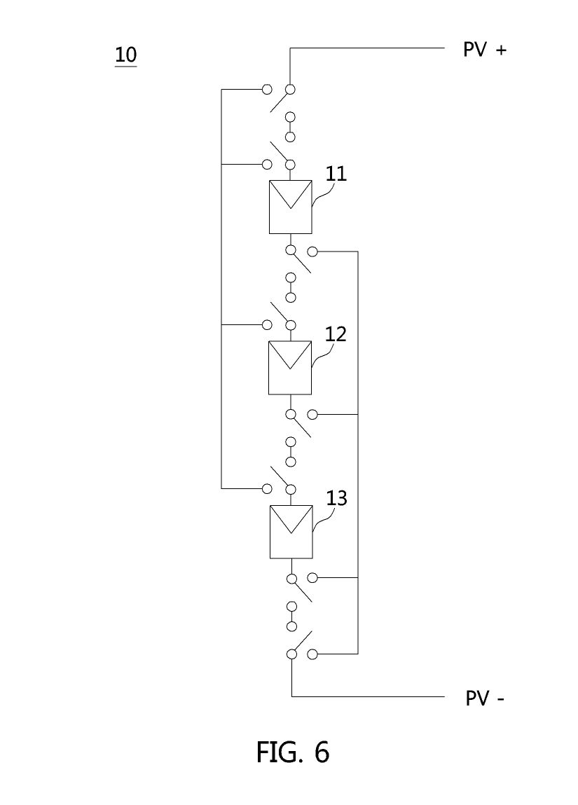

FIG. 6 is a block diagram illustrating the power generation device according to an embodiment of the present invention.

Referring to FIG. 6, the power generation device 10 according to the embodiment of the present invention may include multiple power generation modules 11, 12, and 13 and multiple switches, and may switch the connection between the multiple power generation modules 11, 12, and 13 to any one of a series-connected configuration and a parallel-connected configuration using the multiple switches depending on the state of the grid 30.

As shown in FIG. 6, a photovoltaic power generator, for example, may output a voltage through two terminals PV+ and PV−. When power generation modules are connected in series, a relatively high voltage may be generated, whereas when the power generation modules are connected in parallel, a relatively low voltage may be generated.

Although three photovoltaic power generation modules are illustrated in FIG. 6, the power generation device may be applied to more than three photovoltaic power generation modules.

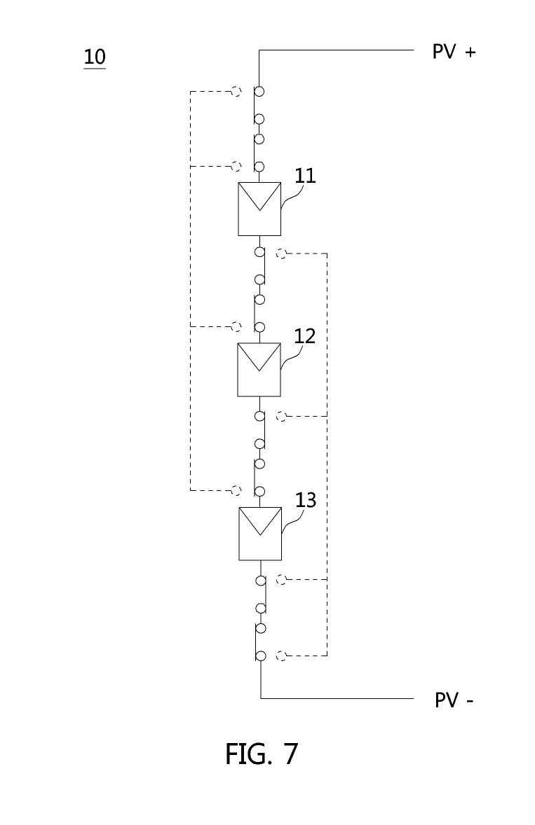

FIG. 7 is a block diagram illustrating the series-connected configuration of the power generation device according to an embodiment of the present invention.

Referring to FIG. 7, it can be seen that the power generation device 10 according to the embodiment of the present invention switches the connection between multiple modules 11, 12, and 13 to a series-connected configuration using multiple switches.

Here, when in any one of a normal mode and a power failure recovery mode, the power generation device 10 may produce power by switching the connection between the multiple power generation modules 11, 12 and 13 to the series-connected configuration using the multiple switches.

Here, the first power conversion unit 110 may perform DC-AC conversion on power, generated at a high voltage by the power generation device 10, and may transmit resulting AC power to the grid 30.

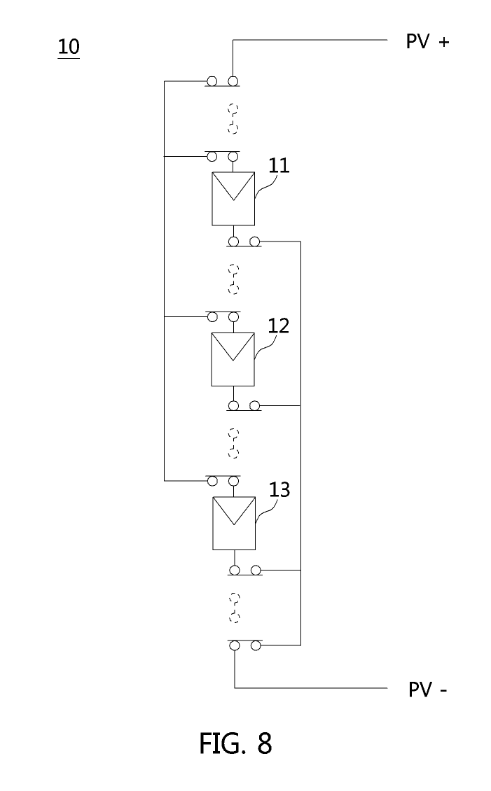

FIG. 8 is a block diagram illustrating the parallel-connected configuration of the power generation device according to an embodiment of the present invention.

Referring to FIG. 8, it can be seen that the power generation device 10 according to the embodiment of the present invention switches the connection between multiple modules 11, 12 and 13 to a parallel-connected configuration using the multiple switches.

Here, when in a power failure mode, the power generation device 10 may produce power by switching the connection between the multiple power generation modules 11, 12, and 13 to the parallel-connected configuration using the multiple switches.

Here, the first power conversion unit 110 may perform DC-DC conversion on the power, generated at a low voltage by the power generation device 10, and may then charge the energy storage device 20.

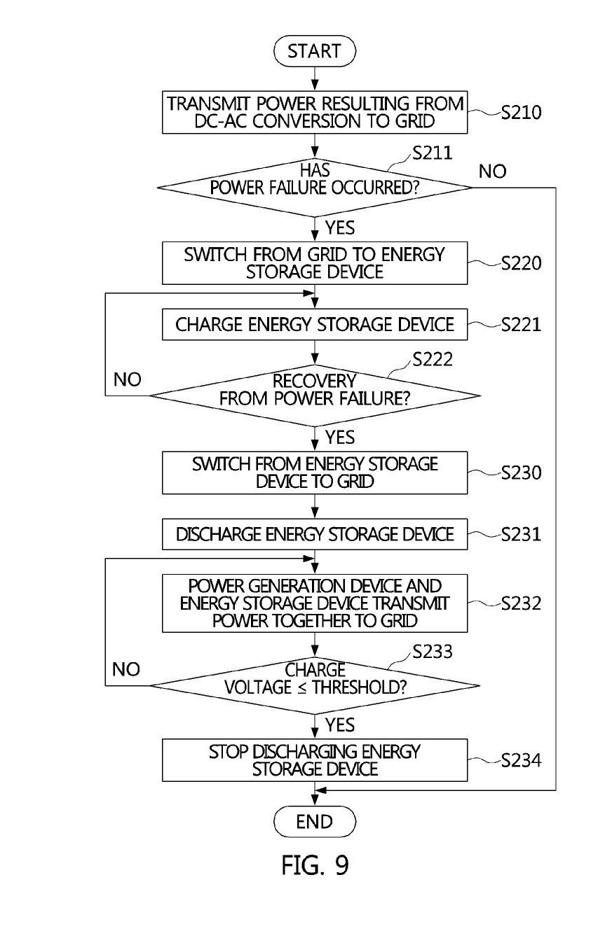

FIG. 9 is an operation flowchart illustrating a power conversion method according to an embodiment of the present invention.

Referring to FIG. 9, the power conversion method according to the embodiment of the present invention may transmit power resulting from DC-AC conversion to the grid at step S210.

That is, at step S210, the power produced by the power generation device 10 may be converted and then transmitted to the grid 30.

Further, the power conversion method according to the embodiment of the present invention may determine whether a power failure has occurred at step S211.

That is, at step S211, when the grid 30 is in a normal state, a normal mode, in which the first power conversion unit 110 is connected to the grid 30, may be performed.

Here, at step S211, when the grid 30 is in a power failure state, a power failure mode in which the first power conversion unit 110 is connected to the energy storage device 20 may be performed by switching the connection between the first power conversion unit 110 and the grid 30 at step S220.

Then, the power conversion method according to the embodiment of the present invention may charge the energy storage device 20 at step S221.

Here, at step S221, in the power failure mode, the DC voltage of the power generation device 10 may be converted into a DC voltage corresponding to the energy storage device 20, and may then charge the energy storage device 20 with the DC voltage.

At step S221, the power generated by the power generation device 10 is charged in the energy storage device 20 through the first power conversion unit 110, and thus the second power conversion unit 120 may not be used.

In this case, step S221, when the voltage of the energy storage device 20 reaches a preset threshold or more, charging may be stopped. Since the voltage of the energy storage device 20 may vary depending on the charged state, the energy storage device 20 stops its operation by itself so that the voltage falls within the range of the operating voltage of the first power conversion unit 110, thus protecting both the first power conversion unit 110 and the energy storage device 20.

Here, when in the power failure mode, the power generation device 10 may generate low-voltage power and then charge the energy storage device 20 with the low-voltage power.

Further, the power conversion method according to the embodiment of the present invention may determine whether the grid 30 is recovering from a power failure at step S222.

That is, at step S222, when the grid 30 is in a power failure recovery state, the power failure recovery mode, in which the first power conversion unit 110 is connected to the grid 30, may be performed by switching the connection between the first power conversion unit 110 and the energy storage device 20 at step S230.

Meanwhile, at step S222, when the grid 30 is not recovering from a power failure and the voltage of the energy storage device 20 is also less than a preset threshold, the energy storage device 20 may be charged at step S221.

Further, the power conversion method according to the embodiment of the present invention may discharge the energy storage device 20 at step S231.

That is, at step S231, when in the power failure recovery mode, a DC voltage discharged from the energy storage device 20 may be converted into a DC voltage corresponding to the power generation device 10, and then the DC voltage may be transmitted to the first power conversion unit 110.

Next, in the power conversion method according to the embodiment of the present invention, both the power generation device 10 and the energy storage device 20 may transmit power together to the grid at step S232.

That is, at step S232, in the power failure recovery mode, the DC voltage of the power generation device 10 may be converted into an AC voltage corresponding to the grid 30, and then the AC voltage may be transmitted to the grid.

Here, at step S232, the power produced by the power generation device 10 and the power discharged from the energy storage device 20 may be transmitted together to the grid 30.

Next, the power conversion method according to the embodiment of the present invention may determine whether the charge voltage of the energy storage device 20 becomes less than or equal to a preset threshold at step S233.

That is, if it is determined at step S233 that the charge voltage of the energy storage device 20 does not become less than or equal to the preset threshold, the energy storage device 20 may be discharged at step S231, and thus the power produced by the power generation device 10 and the power discharged from the energy storage device 20 may be transmitted together to the grid 30 at step S232.

Further, the power conversion method according to the embodiment of the present invention may stop discharging the energy storage device 20 at step S234.

That is, at step S234, when the charge voltage of the energy storage device 20 becomes less than or equal to the preset threshold, the second power conversion unit 120 and the energy storage device 20 stop their respective operations, and the operation mode of the power conversion apparatus 100 may be changed to the normal mode, as shown in FIG. 3.

The present invention may efficiently use power produced by a power generator even when a grid is in a power failure state.

Further, the present invention may contribute to the recovery of the power failure state of a grid.

As described above, in the power conversion apparatus and method according to the present invention, the configurations and schemes in the above-described embodiments are not limitedly applied, and some or all of the above embodiments can be selectively combined and configured such that various modifications are possible.

What is claimed is:

1. A power conversion apparatus comprising:
a first power conversion unit for converting power produced by a power generation device while being connected to the power generation device, and transmitting the converted power to any one of a grid and an energy storage device;
a second power conversion unit for converting power discharged from the energy storage device while being connected to the energy storage device, and transmitting converted power to the first power conversion unit; and
a switch control unit for switching the first power conversion unit to any one of the grid and the energy storage device depending on a state of the grid, and then transmitting power of the first power conversion unit.

2. The power conversion apparatus of claim 1, wherein the switch control unit is configured to, when the grid is in a normal state, perform a normal mode in which the first power conversion unit is connected to the grid.

3. The power conversion apparatus of claim 2, wherein the switch control unit is configured to, when the grid is in a power failure state, perform a power failure mode, in which the first power conversion unit is connected to the energy storage device, by switching a connection between the first power conversion unit and the grid.

4. The power conversion apparatus of claim 3, wherein the switch control unit is configured to, when the grid is in a power failure recovery state of recovering from a power failure, perform a power failure recovery mode, in which the first power conversion unit is connected to the grid, by switching a connection between the first power conversion unit and the energy storage device.

5. The power conversion apparatus of claim 4, wherein the first power conversion unit is configured to, when in the power failure mode, convert a Direct Current (DC) voltage of the power generation device into a DC voltage corresponding to the energy storage device, and then charge the energy storage device with the DC voltage.

6. The power conversion apparatus of claim 5, wherein the first power conversion unit is configured to, when in any one of the normal mode and the power failure recovery mode, convert the DC voltage of the power generation device into an Alternating Current (AC) voltage corresponding to the grid, and transmit the AC voltage to the grid.

7. The power conversion apparatus of claim 6, wherein the second power conversion unit is configured to, when in the power failure recovery mode, convert a DC voltage discharged from the energy storage device into a DC voltage corresponding to the power generation device and transmit the DC voltage to the first power conversion unit.

8. The power conversion apparatus of claim 7, wherein the second power conversion unit is configured to, when in the power failure recovery mode, discharge the energy storage device until a charge voltage of the energy storage device becomes less than or equal to a preset threshold.

9. The power conversion apparatus of claim 8, wherein the power generation device is configured to, when in any one of the normal mode and the power failure recovery mode, produce high-voltage power and transmit the high-voltage power to the grid and, when in the power failure mode, produce low-voltage power and charge the energy storage device with the low-voltage power.

10. The power conversion apparatus of claim 9, wherein:
the power generation device comprises multiple power generation modules and multiple switches, and
the power generation device switches a connection between the multiple power generation modules to any one of a series-connected configuration and a parallel-connected configuration using the multiple switches depending on a state of the grid.

11. The power conversion apparatus of claim 10, wherein the power generation device is configured to, when in any one of the normal mode and the power failure recovery mode, produce power by switching the connection between the multiple power generation modules to the series-connected configuration using the multiple switches.

12. The power conversion apparatus of claim 11, wherein the power generation device is configured to, when in the power failure mode, produce power by switching the connection between the multiple power generation modules to the parallel-connected configuration using the multiple switches.

13. A power conversion method using a power conversion apparatus, comprising:
when a grid connected to the power conversion apparatus is in a normal state, converting power produced by a power generation device and transmitting the converted power to the grid;
when the grid is in a power failure state, charging the power produced by the power generation device in an energy storage device; and
when the grid is in a power failure recovery state of recovering from a power failure, discharging the energy storage device and transmitting power, discharged from the energy storage device, together with the power produced by the power generation device, to the grid.

14. The power conversion method of claim 13, wherein converting the power and transmitting the converted power to the grid is configured to, when the grid is in the normal state, perform a normal mode in which the power generation device is connected to the grid.

15. The power conversion method of claim 14, wherein converting the power and transmitting the converted power to the grid is configured to, when in the normal mode, convert a DC voltage of the power generation device into an AC voltage corresponding to the grid and transmit the AC voltage to the grid.

16. The power conversion method of claim 15, wherein charging the power in the energy storage device is configured to, when the grid is in the power failure state, perform a power failure mode, in which the power generation device is connected to the energy storage device, by switching a connection between the power generation device and the grid.

17. The power conversion method of claim 16, wherein charging the power in the energy storage device is configured to, when in the power failure mode, convert the DC voltage of the power generation device into a DC voltage corresponding to the energy storage device, and then charge the energy storage device with the DC voltage.

18. The power conversion method of claim 17, wherein discharging the energy storage device and transmitting the discharged power, together with the power produced by the power generation device, to the grid is configured to, when the grid is in the power failure recovery state, perform a power failure recovery mode, in which the power generation device is connected to the grid, by switching a connection between the power generation device and the energy storage device.

19. The power conversion method of claim 18, wherein discharging the energy storage device and transmitting the discharged power, together with the power produced by the power generation device, to the grid is configured to, when in the power failure recovery mode, convert a DC voltage discharged from the energy storage device into a DC voltage corresponding to the power generation device, convert the DC voltage, together with the power produced by the power generation device, into an AC voltage corresponding to the grid, and transmit the AC voltage to the grid.

20. The power conversion method of claim 19, wherein discharging the energy storage device and transmitting the discharged power, together with the power produced by the power generation device, to the grid is configured to, when in the power failure recovery mode, discharge the energy storage device until a charge voltage of the energy storage device becomes less than or equal to a preset threshold.
